(19) United States
(12) Patent Application Publication
(10) Pub. No.: US 2010/0013940 A1
(43) Pub. Date: Jan. 21, 2010

(54) IMAGE PROCESSING APPARATUS

(75) Inventor: Fuminori Takahashi, Nagano (JP)

Correspondence Address: PATENT DOCKET CLERK;COWAN, LIEBOWITZ & LATMAN, P.C., 1133 AVENUE OF THE AMERICAS, NEW YORK, NY, 10036, US

(73) Assignee: NITTOH KOGAKU K.K., Nagano (JP)

(21) Appl. No.: 11/917,980

(22) PCT Filed: Jun. 14, 2006
(86) PCT No.: PCT/JP2006/311946

§ 371 Date: Dec. 18, 2007

(30) Foreign Application Priority Data
Jun. 21, 2005 (JP) 2005-180336
Jul. 26, 2005 (JP) 2005-216388
Aug. 4, 2005 (JP) 2005-227094

(51) Int. Cl. G06K 9/40; G06K 9/68

(52) U.S. Cl. 348/208.6; 382/255

(57) ABSTRACT

A circuit processing a method is provided that is more practical for restoring an image as well as preventing a device from becoming large. The image processing device includes an image processing unit for processing an image. The processing unit produces restored data approaching to an initial image data before fluctuating by repeating the following processes: generating comparison data Io′ from arbitrary signal data Io by using data G of fluctuation factor information that triggers image fluctuation; comparing the comparison data Io′ with original image data Img′ as an object to be processed thereafter; producing a restored data Io+n by allocating a difference data δ to the arbitrary image data Io while using the data G of fluctuation factor information; and substituting the restored data Io+n for the arbitrary signal data Io thereafter. Further, various methods using the above basic processing can also be applied.

### TECHNICAL FIELD

The present invention relates an image processing device.

### BACKGROUND OF TECHNOLOGY

It is conventionally known that an image is blurred upon taking a picture with a camera and the like. A blur of an image is mainly due to hand-jiggling upon taking a picture, various aberrations in optics, lens distortion and the like.

In order to stabilize an image, there are two methods, moving lens and electronic processing. As a method of moving a lens, for example, the patent document 1 discloses a method of stabilizing an image by detecting hand-jiggling and moving a predetermined lens in response to jiggling.

As a method of electronic processing, the document 2 discloses a method of producing a restored image by detecting displacement of a camera's optical axis with an angular velocity sensor, gaining a transfer function that shows a blurry state upon taking a picture from detected angular velocity, and inversely transforming the gained transfer function about a shot image.
[Patent Document 1] Unexamined patent publication H6-317824 (see the summary.)
[Patent Document 2] Unexamined patent publication H11-24122 (see the summary.)

### PROBLEM TO BE SOLVED

A camera, equipped with a method of stabilizing an image shown in the patent document 1, becomes a large size because of necessity of a space for mounting hardware for driving a lens such as motor and the like. Further, installing such hardware and a driving circuit for driving the hardware needs to increase a cost.

Further, a method of stabilizing an image shown in the patent document 2 includes following issues, although the method does not have the above mentioned problem. Namely, following two issues cause difficulty of producing a restored image in actual; though inversed transformation of a gained transfer function theoretically produces a restored image.

First, the gained transfer function is extremely weak in handling noises and information errors about a blur and slight variation of them greatly affects the values of the function. This variation results in a disadvantage in that a restored image produced by the inversed transformation is far from a stabilized image without hand-jiggling and out of use in actual. Second, the inverse transformation factoring noises sometime needs a method of estimating solutions by using singular value decomposition about solutions in simultaneous equations. But calculated values for such estimation run into astronomical numbers, actually yielding a high risk of remaining unsolved.

The advantage of the invention is to provide an image processing device realizing a practical image processing of restoring image data as well as preventing the device from becoming a large size.

### SUMMARY OF THE INVENTION

In order to solve the above mentioned issues, the image processing device of the present invention produces restored data by repeating processes without using the inversed transfer function.

The aspect of the invention produces restored data approaching to an original image by only producing predetermined data through using data of fluctuation factor information that triggers image fluctuation. This processing does not need an increase of additional hardware, not making a device a large size. Further the processes of producing comparison data from restored data and comparing the comparison data with the original image data as an object to be processed are repeated, obtaining the restored data that gradually approaches to an image before fluctuation which is a base for an original image. These processes realize practical restoring operations. Hence, these processes can provide an image processing device that includes a system of circuitry for processing in order to restore an image.

According to other aspect of the invention, an image processing device repeats the processes of reduced data as an object to be processed, and then produces restored data by using a transfer function obtained from restored data which is a reduced image.

According to this aspect of the invention, the repetition of the processes in order to obtain reduced and restored data approaching to the initial image before fluctuation, which is a base for the original image, is combined with deconvolution processing using a transfer function. This combined processing prevents a device from being a large size, realizes more practical restoring operation and enhances high speed processing.

Further, a reduced data of the original image is produced by thinning the original image data. A processing unit may attain a new transfer function by reversely multiplying the transfer function with the reduce ratio of reduced original image data to the original image and interpolating a enlarged space, and then produce the restored data approaching to the initial image by using the new transfer function. These processes can attain the transfer function corresponding to an entire image.

Further, the reduced data of an original image may be produced by directly retrieving a part of region from original image data. This process can attain a transfer function corresponding to a part of a region and being applied to an entire image.

Further, according to other aspect of the invention, an image processing device produces superimposed-restored data by superimposing image data to be processed on data for superimposing and repeating the processes by using image attained by such superimposing. Then, a superimposed portion is removed.

According to this aspect of the invention, the data for superimposing based on already-known image data is superimposed on the original image data as an object to be processed. Such superimposing shortens processing time while changing image quality even if it takes long time to produce the restored image. Further, it provides an image processing device including a method of practical circuit processing while preventing the device from become a large size.

Further, the already-known image data may favorably be image data which shows less contrast comparing to the original image before fluctuation. By using the image data, data which is an object to be processed for producing a superimposed restored image data, becomes image data having further less contrast, and reduces time for processing.

Further, according to other aspect of the invention, an image processing device produces restored data, approaching to an original image before fluctuation, by calculating error component data within the restored data attained through repetition of processing in some degrees, and removing the error component data from the restored data.

The aspect of the invention can attain the error component data, and calculate the restored data, approaching to the original image, by removing the error component data included in the restored data from the restored data attained with repetition of processing in some degrees. Such calculation can shorten processing time. Further, it provides an image processing device including a method of practical circuit processing while preventing the device from being a large size.

Further, the above calculation of the error component data may comprise: producing fluctuated image data of first restored data from the first restored data by using data of fluctuation factor information; adding the fluctuated image data to original image data as an object to be processed; producing second restored data by restoring the added data; obtaining error component data by using the second restored data and the first restored data. The above processes can simplify a processing structure since the second restored data is produced by a process that is the same of producing the first restored data.

The processing unit may preferably halt the repetition of the processes if the difference data become equal to or less or smaller than a predetermined value. This halt can avoid long time processing since the processes are halted before “zero” difference. Further, setting the difference data equal to or less than a predetermined value can further approximate the restored data to an image before fluctuation(before blurring) as base of an original image. Further, even upon yielding noises may bring a situation of “zero” difference, which is not actually happened, the above halt can avoid unlimited repetition.

Further, the processing unit may favorably halt the repetition of the processes if the number of the repetition becomes a predetermined number. This halt can avoid long time processing since the processes are halted in spite that the difference becomes “zero” or does not. Further, the processes are repeated by the predetermined numbers. This repetition can further approximate the restored data to the image data before fluctuating, which will be a base for an original image. Further, even when yielding noises may bring a situation of none “zero”□difference, which is actually happened, the above halt can avoid unlimited repetition since the repetition is completed by the predetermined number.

Further, in case of the repetition of the processes, the processing unit may halt the repetition if the difference data at the time when the numbers of repetition reaches the predetermine number, is equal to or less or smaller than the a predetermined number, and may continue the repetition by the predetermined number if the difference data is equal to or more or larger than the predetermined number. In this aspect of the invention, combining the number of process repetition with the difference value can attain favorite balance between image quality and short processing time compared to a case of simply limiting the number of the repetition or limiting the difference value.

### ADVANTAGE OF THE INVENTION

The advantage of the invention is to provide an image processing device that realizes practical image processing of restoring image data as well as preventing the device from becoming a large size.

### BRIEF DESCRIPTION OF DRAWINGS

FIG. 1 is a block diagram showing a main structure of an image processing device of a first embodiment in the invention.

FIG. 2 is a perspective and schematic view showing an overall concept of the image processing device shown in FIG. 1 and the location of an angular speed sensor.

FIG. 3 is a flow chart showing a method of processing (a processing routine) implemented by a processing unit in the image processing device shown in FIG. 1

FIG. 4 is a diagram explaining a concept of the processes method shown in FIG. 3.

FIG. 5 is a chart concretely explaining the processes method shown in FIG. 3 as an example of hand-jiggling and a table of energy concentration without hand-jiggling.

FIG. 6 is a chart concretely explaining the processes method shown in FIG. 3 as an example of hand-jiggling and a diagram showing image data without hand-jiggling.

FIG. 7 is a chart concretely explaining the processes method shown in FIG. 3 as an example of hand-jiggling and a diagram showing energy dissipation upon hand-jiggling.

FIG. 8 is a chart concretely explaining the processes method shown in FIG. 3 as an example of hand-jiggling and a diagram showing production of comparison data from an arbitrary image.

FIG. 9 is a chart concretely explaining the processes method shown in FIG. 3 as an example of hand-jiggling and a diagram showing production of difference data by comparing comparison data with a blurred original image, an object to be processed.

FIG. 10 is a chart concretely explaining the processes method shown in FIG. 3 as an example of hand-jiggling and a diagram showing production of restored data by allocating and adding difference data to an arbitrary image.

FIG. 11 is a chart concretely explaining the processes method shown in FIG. 3 as an example of hand-jiggling and a diagram showing generation of new comparison data from restored data and difference data by comparing the comparison data with a blurred original image as an object to be processed.

FIG. 12 is a chart concretely explaining the processes method shown in FIG. 3 as an example of hand-jiggling and a diagram showing production of new restored data by allocating new difference data.

FIG. 13 is a diagram explaining a method performed by a processing unit in an image processing device of a second embodiment, which is a second method using the method shown in FIG. 3. The left side is data of an original image as an object to be processed and the right side is a diagram showing data obtained by thinning the original image data.

FIG. 14 is a flow chart of the second processing method shown in FIG. 13.

FIG. 15 is a diagram explaining a method performed by the processing unit in the image processing device of the second embodiment, which is a third method using the method shown in FIG. 3. The left side is data of an original image as an object to be processed and the right side is a diagram showing data obtained by retrieving a part of the original image data.

FIG. 16 is a flow chart of the third processing method shown in FIG. 15.

FIG. 17 is a diagram explaining the modification of the third method shown in FIGS. 15 and 16 and showing that a part of a region is retrieved for repetition of processing from the divided region.

FIG. 18 is a process flow chart explaining a method performed by a processing unit in an image processing device of the third embodiment, which is a fourth method using the method shown in FIG. 3

FIG. 19 is a process flow chart explaining a method performed by a processing unit in the image processing device of the fourth embodiment, which is a fifth method (process routine) using the method shown in FIG. 3.

FIGS. 20(A) and 20(B) are a diagram explaining a process using a barycenter of fluctuation factors as a six method by using a method shown in FIG. 3. FIG. 20(A) is a diagram in which one pixel among corrected image data is paid attention. FIG. 20(B) is a diagram in which data of the pixel, paid attention, are dispersed in data of original image data.

FIG. 21 is a diagram concretely explaining a process of using a barycenter of fluctuation factors as the sixth method shown in FIG. 20.

### REFERENCE NUMERALS

1: image processing device

4: processing unit,

5: recording unit,

Io: data of an initial image (data of an arbitrary image)

Io′: comparison data,

G: data of fluctuation-factor information (data of information about blurring factors)

Img′: data of an original image (a shot image)

σ:difference data,

k: allocation ratio

Io+n: restored data (restored image data)

Img: data of an intrinsic correct image without blurring

ISmg′: reduced original image data

GS: reduced data of fluctuation factor information

ISmg: reduced initial image

ISo+n: approximated, reduced, and restored data

B: already-known image data

B′: image data for superimposing

C′: superimposed image data

D: image data of restoring an original image

Img1: first restored data

v: error component data

Img2′: added data

Img3: second restored data

### DETAILED DESCRIPTION OF PREFERRED EMBODIMENTS OF THE INVENTION

### First Embodiment

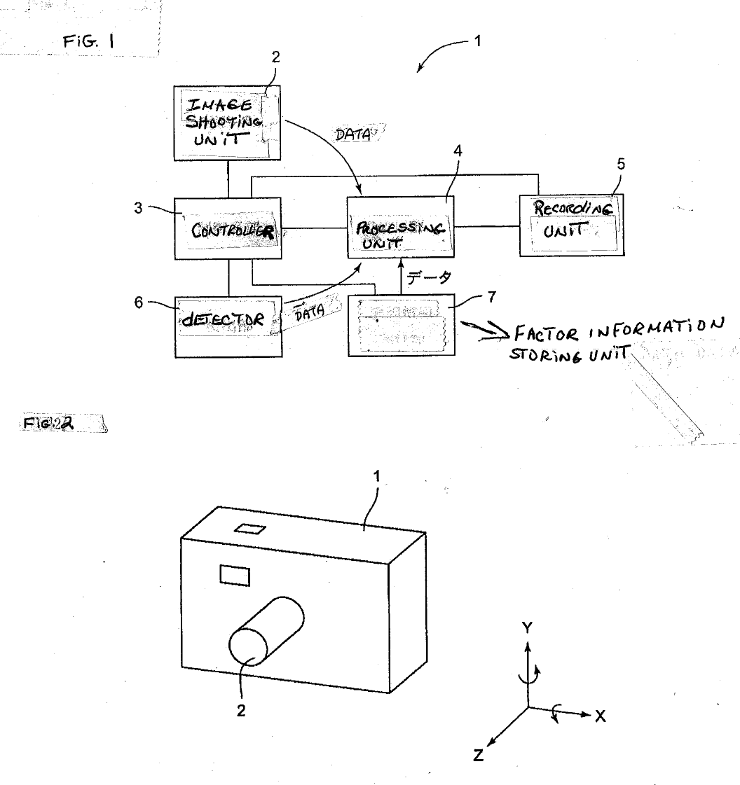

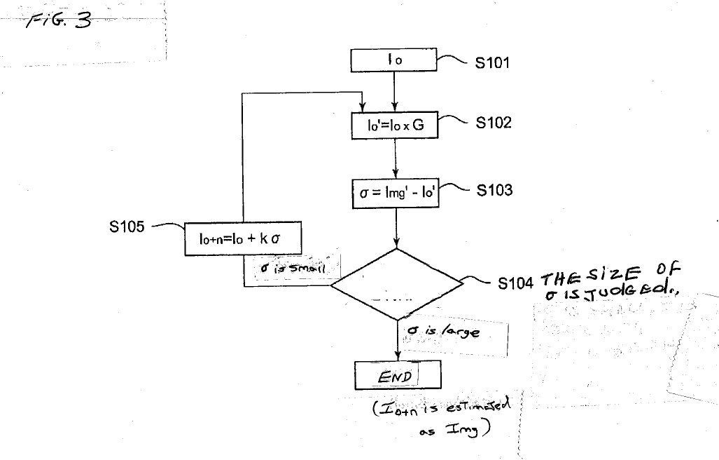

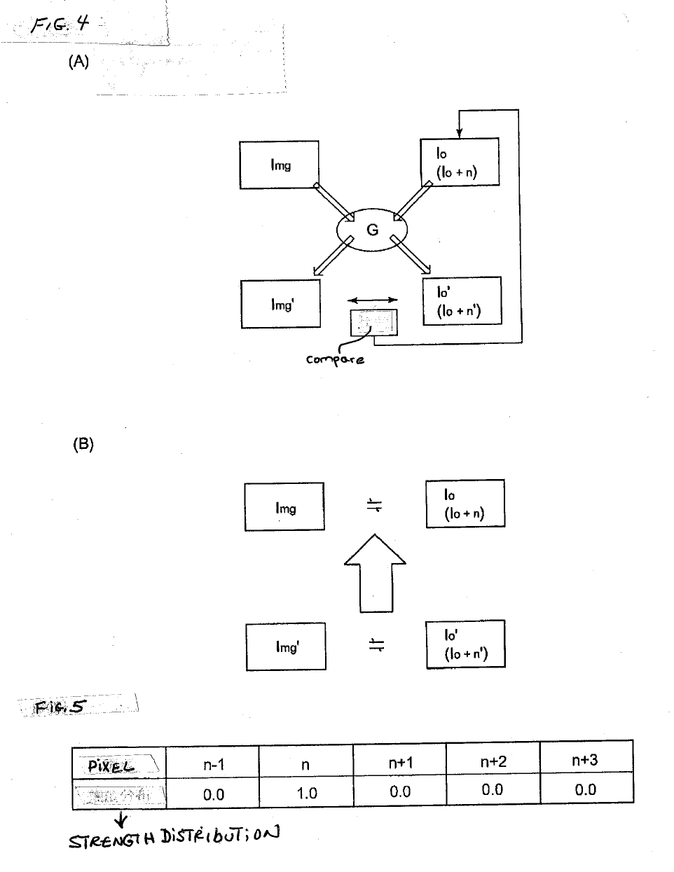

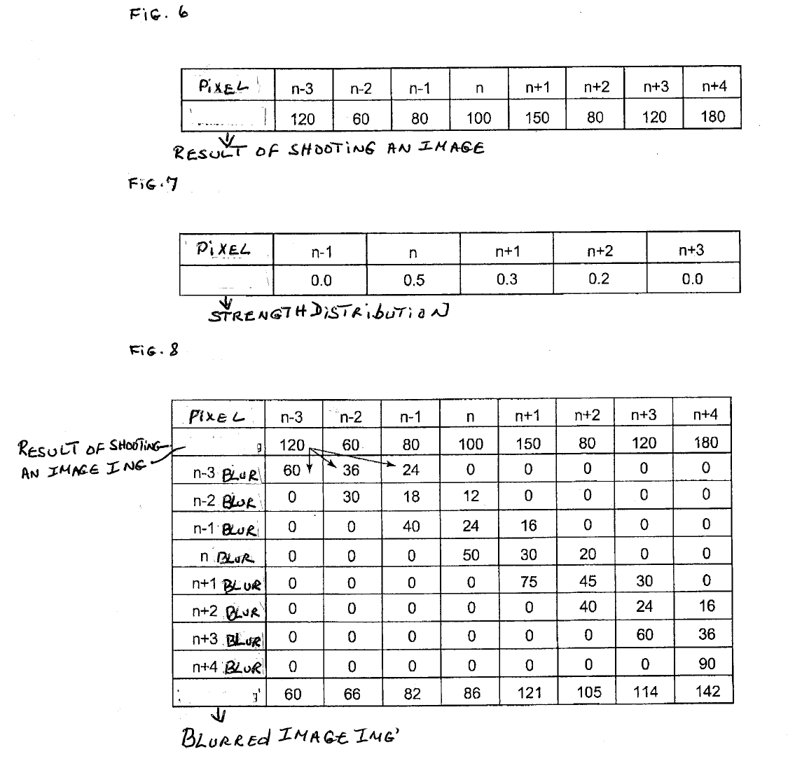

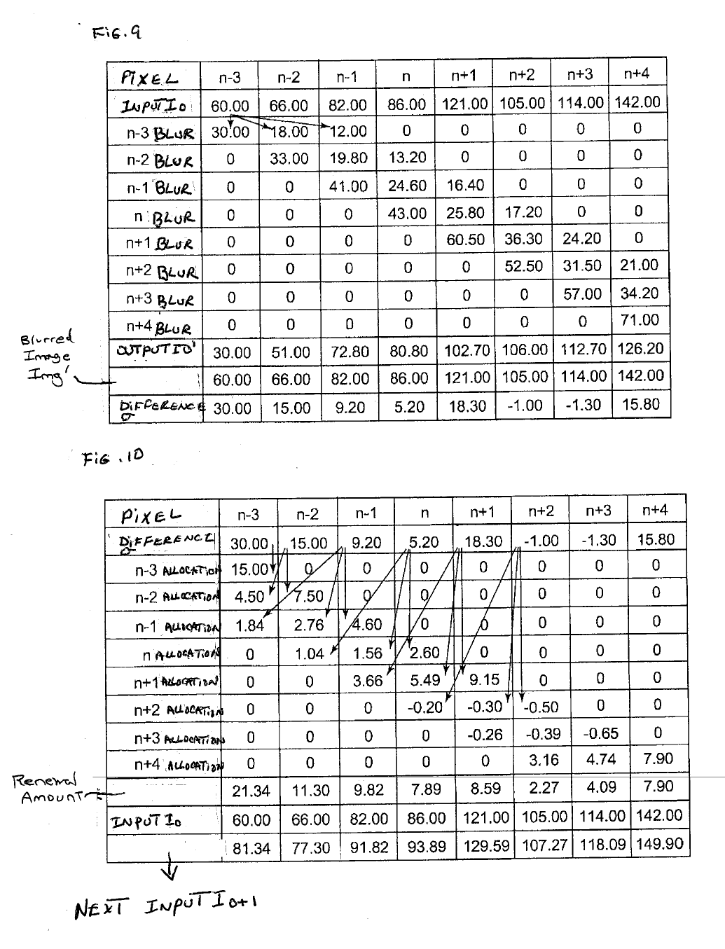

A first embodiment of the invention will be explained with referring to FIG. 1 to FIG. 12. The image processing unit 1 in the first embodiment is an image processing unit used for a consumer camera, but also applied to cameras for other use such as monitoring, TV, and an endoscope, and other devices except cameras such as a microscope, binoculars, and a diagnostic imaging apparatus like imaging with NMR.

The image processing device 1 comprises an imaging unit 2 for shooting an image such as a figure, a controller 3 for driving the imaging unit 2 and a processing unit 4 for processing an image (signal data) shot by the imaging unit 2. The image processing device 1 further comprises a recording unit 5 for recording an image processed by the processing unit 4, an angular speed sensor, a detector 6 for detecting fluctuation factor information, which is a main factor for an image blur, and a fluctuation-factor information storing unit 7.

The imaging unit 2 is a unit provided with an imaging optics having lens and an imaging element converting a light image passed through lens into electrical signals such as a charged coupled device (CCD) and a complementary metal oxide semiconductor (CMOS). The controller 3 controls any units of the image processing device 1 such as the imaging unit 2, the processing unit 4, the recording unit 5, the detector 6 and the factor information storing unit 7.

The processing unit 4 includes an image processing processor composed of hardware such as application specific integrated circuit (ASIC). The processing unit 4 may store an image which becomes a base for generating comparison data described later. The processing unit 4 may comprise software instead of hardware like ASIC. The recording unit 5 includes a semiconductor memory, but may include a magnetic recording means like a hard disk drive or an optical recording means like digital versatile disk (DVD).

The detector 6 is provided with two angular speed sensors, detecting the angular speed along X axis and Y axis perpendicular to Z axis, which is the, optical axis of the image processing device 1 as shown in FIG. 2. Hand-jiggling when shooting an image with a camera generates any movements along X, Y and Z directions and rotation along Z axis. But, in particular, rotations along X and Y axes receive the most impact of hand-jiggling. A shot image is greatly blurred even if these rotations fluctuate slightly. Only two angular sensors are placed along X and Y axes in FIG. 2 in the embodiment due to the above reason. But, other angular sensor along Z axis and sensors detecting movement along X and Y directions may be added in order to get further accurate detection. A sensor may be an angler acceleration sensor instead of an angler velocity sensor.

The factor-information storing unit 7 is a recoding unit which records information regarding fluctuation factors such as already-known blur factors like aberration of optics and others. In the embodiment, the factor information storing unit 7 stores information of aberration of optics and lens distortion. But such information is not used for restoring a blurred image due to hand-jiggling described later.

Next, a processing method performed by the processing unit 4 in the image processing device 1 will be explained with referring to FIG. 3.

In FIG. 3, “Io” is an arbitrary initial image, image data which has previously been recorded by the recording unit in the processing unit 4. “Io′” is blurred image data of the initial image data Io, comparison data for comparing. “G” is data of fluctuation-factor information (=information about blur factors (point image functions)) detected by the detector 6 and stored by the recording unit in the processing unit 4. “Img′” is a shot image, namely blurred image data, which become original image (original signal) data, an object to be processed in the processes.

“σ” is difference data between the original image data Img′ and the comparison data Io′. “k” is an allocation ratio based on fluctuation-factor information. “Io+n” is restored image data (restored data), newly produced by allocating the difference data σ to the initial image data Io based on the data of fluctuation-factor information. “Img” is intrinsic-correct image data without a blur, which is a base of the original image data “Img′”, a blurred image when it was shot. Here the relationship between Img and Img′ is assumed to be expressed as the following formula (1)

Img′=Img×G (1)

Where, “x” is an operator for superimposing integration. Here, the difference “δ” is generally varied by the data G of fluctuation-factor information and expressed as the following formula (2), though the data may be a simple difference of a corresponding pixel.

σ=f(Img′, Img, G) (2)

With respect to a routine processed by the processing unit 4, first, arbitrarily image data Io is prepared (step S101). The initial image data Io may be the shot blurred image data Img′ or may be any image data having solid black, solid white, solid gray, check and the like. Step S102 obtains the comparison data Io′ as the blurred image by inputting the arbitrary image data Io, which becomes the initial image, to the formula (1) instead of Img. Next, the difference data σ is calculated by comparing the original image data Img′ as the shot and blurred image with the comparison data Io′(step S103).

Step S104 judges the difference data σ whether it is equal to or more than a predetermined value or not. Then, step S105 produces newly restored image data (restored data) if the difference data σ is equal to or more than a predetermined value. Namely, newly restored data Io+n is produced by allocating the difference data CY to the arbitrary image data Io based on the data G of fluctuation-factor information. Steps S102, S103 and S104 are repeated thereafter.

If step S104 judges the difference data σ as being smaller than the predetermined value, the processes are halted (step S106). Then, the restored data Io+n at the time of halting the processes are assumed to be a correct image, namely an image data Img without a blur. Then this correct data is recorded to the recording unit 5. Here, the recording unit 5 may record the initial image data Io and the data G of fluctuation-factor information and send them to the processing unit 4 if they are necessary.

The above processing method will be summarized as the followings. Namely, this method does not gain solutions as solving inverse issues, but gain solutions as optimizing issues to seek rational solutions. As disclosed in the patent document 2, solving inverse issues is theoretically possible, but faces difficulty in actual site.

Gaining solutions as optimizing issues needs the following premises:
(1) An output corresponding to an input is uniquely determined.
(2) If an output is the same, an input is the same.
(3) The processes are repeated while updating inputs in order to gain the same output so as to make a solution converge.

In other words, as shown in FIGS. 4(A) and 4(B), if producing the comparison data Io′ (Io+n′) approaching to the original image data Img′ as the shot image is produced, the initial image data Io, which is the initial data for such production, or the restored data Io+n, approximates to the correct image data Img which becomes a base for the original image data Img′.

Here, in the embodiment, the angular velocity sensor detects an angular velocity every 5 μsec. The value for judging the difference data σ is “6” in the embodiment when each data is expressed as 8 bits (0 to 255). Namely, when the difference data is smaller than 6, equal to or less than 5, the processes are halted. Row data of fluctuation detected by the angular velocity sensor is not coincided with actual fluctuation if correcting the sensor is insufficient. Therefore, it is necessary to compensate the detected raw data such as multiplying it with a predetermined magnification in order to fit the actual fluctuation when the sensor is not corrected.

Next, the details of the processes shown in FIGS. 3 and 4 will be explained with referring to FIGS. 5,6,7,8,9,10,11, and 12.

[Restoring Algorism on Hand-Jiggling]

Upon no hand-jiggling, optical energy corresponding to a predetermined pixel concentrates on the pixel during exposure. But upon hand-jiggling, optical energy disperses to pixels blurred during exposure. Further, if the degree of hand-jiggling during exposure is recognized, the way of making optical energy dispersion during exposure is also recognized. Therefore, it is possible for the recognition to produce a non blurred image from a blurred image.

Details will be explained as a horizontal one dimension for simplicity. Pixels are defined as n−1,n, n+1.n+2,n+3 from a left side and a pixel “n” is paid to attention. When no hand-jiggling, energy during exposure concentrates to the pixel, making the energy concentration become “1.0”. This energy concentration is shown in FIG. 5. The table in FIG. 6 shows the results of shot images under the above energy concentration. These results shown in FIG. 6 become the correct image data Img without a blur. Here, each data is shown as 8 bits (0 to 255).

Upon hand-jiggling during exposure, an image is supposed to be blurred to the nth pixel during 50% of exposure time, the (n+1) pixel during 30% of it and the (n+2)th pixel during 20% of it. The way of making energy dispersion is shown in the table of FIG. 7. This dispersion becomes the data G of fluctuation factor information.

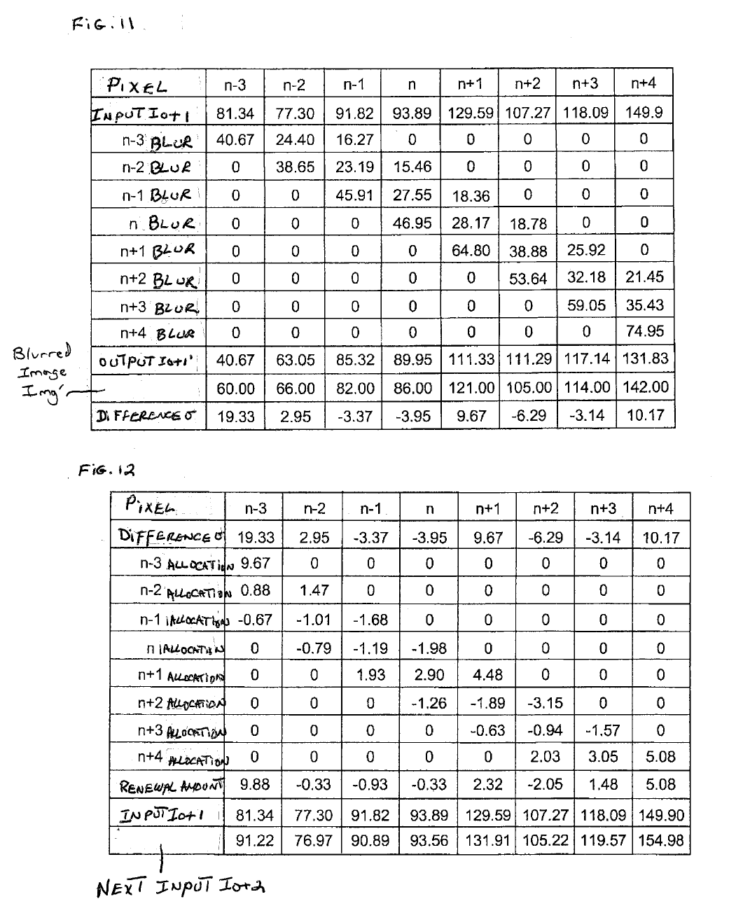

A blur is uniform on all pixels. If there is no upper blur (vertical blur), the status of a blur is shown in the table of FIG. 8. In FIG. 8, data shown as “shot results” is the intrinsic-correct image Img and data shown as “blurred images” is the shot blurred image data Img′. More specifically, the image data “120” at the “n−3” pixel follow the allocation ratio of the data G of fluctuation-factor information “0.5”, “0.3” and “0.2”. Hence, the image data disperses to the “n−3” pixel by “60”, the “n−2” pixel by “36”, and the “n−1” pixel by “24”. Similarly, the image data “60” of the “n−2” pixel disperses to the “n−2” pixel by “30”, the “n−1” pixel by “18” and the “n” pixel by “12”. The corrected-shot results without blur is calculated from the blurred image data Img′ and the data G of fluctuation-factor information shown in FIG. 7

In this explanation, the shot-original image data Img′ is used as the arbitrary image data Io shown in step S101, though any kinds of data can be applied to such data. Namely, Io is defined to be equal to Img′ at the beginning. “Input” shown in the table of FIG. 9 corresponds to the initial image data Io. Step S102 multiplies the data Io, namely Img′ with the data G of fluctuation-factor information. More specifically, the data “60” at “n−3” pixel of the initial image data Io, for example, is allocated to the “n−3” pixel by “30”, the “n−2” pixel by “18” and the “n−1” pixel by “12”. Other image data at other pixels are similarly allocated. Then, the comparison data Io′ is produced, being indicated as “output Io′”. Therefore, the difference data σ in step S103 becomes values shown in the bottom of the table in FIG. 9.

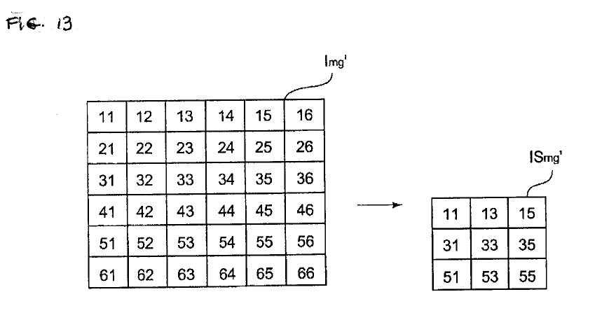

Then the size of the difference data σ is judged in Step S104. More specifically, if the absolute values of all the difference data σ become equal to or less than 5, the processes are halted. But, the difference data σ shown in FIG. 9 is not matched to this condition, then the processes moves to step S105. Namely, the newly restored data Io+n is produced by allocating the difference data σ to the arbitrary image data with using the data G of fluctuation factor information. The newly restored data Io+n is indicated as “next input” in FIG. 10. This case is first processing indicated as Io+1 in FIG. 10.

The difference data σ is allocated by the following. The data “30” at the “n−3” pixel, for example, is allocated to the “n−3” pixel by “15” which is obtained through multiplying “30” with “0.5”, the allocation ratio at the “n−3” pixel itself. The data “15” at the “n−2” pixel is allocated to the “n−2” pixel by “4.5” which is obtained through multiplying “15” with “0.3”, the allocation ratio at the “n−2” pixel. The data “9.2” at the “n−1” pixel is allocated to the “n−1” pixel by “1.84” which is obtained through multiplying “9.2” with “0.2”, the allocation ratio at the “n−1” pixel. The total amount allocated to “n−3” pixel becomes “21.34”. The restored data Io+1 is produced by adding this value to the initial image data Io (the shot-original image data Img′ here).

As shown in FIG. 11, the restored data Io+1 becomes input image data (the initial image data Io) in step S102 for executing step 102. Then new difference data σ is obtained by proceeding step S103. The size of the new difference data σ is judged instep S104. If the data is larger than a predetermined value, the new difference data σ is allocated to the previous restored data Io+1 so that the new restored data Io+2 is produced (see FIG. 12). Then, the new comparison data Io+2′ is produced from the new restored data Io+2 during executing step S102. As already explained, after step S102 and S103 are executed, step S104 is executed. Then, depending on the judge in step S104, either step S105 or step S106 is executed. These processes are repeated.

The image processing device 1 is able to fix either the numbers of processing or a reference value for judging the difference data σ in advance or both of them during step S104. Repeating numbers for processing can be fixed to be arbitrary such as 20 or 50 for example. Further, the value of difference data σ is set to be “5” among 8 bits (0 to 255) for halting the processes. If the data becomes equal to or less than 5, the processes can be completed. Otherwise, if the value is set to be “0.5” and the data becomes equal to or less than “0.5”, the processes can be completed. The value can be arbitrarily fixed. Upon inputting both the numbers of repeating processing and the reference value for judging, the processes are halted if either one of them is satisfied. Here, if setting both is possible, the reference value for judging may be prioritized and the predetermined numbers of repeating the processes can be further repeated if the difference data does not become within the range of the reference value for judging by repeating predetermined numbers.

In the embodiment, information stored in the factor information storing unit 7 is not used. But, already-known and blur-factor data such as optical aberration and lens distortion may be used. In this case, in the processes shown in FIG. 3, for example, it is preferable that processing be performed by combining hand-jiggling information with optical aberration as one blur information. Otherwise, an image may be stabilized by using optical aberration information after completing the processes with using hand-jiggling information. Further, an image may be corrected or restored only by movement factors at the time shooting such as hand-jiggling without setting the factor information storing unit 7.

### Second Embodiment

In the second embodiment, an image processing device has the same structure of the image processing device 1 in the first embodiment. But, a processing method performed by the processing unit 4 is different. But, the basic concept of the repetition of the processes in the second embodiment is the same in the first embodiment. Hence, major differences will be explained.

In order to speed up the restoring process during repetition of the processes, there is a method of combining the repetition with an inverse issue. Namely, the processes are repeated with reduced data and a transfer function is calculated from the reduced original image to transfer reduced-restored data. Then the calculated- transfer function is enlarged and interpolated. The restored data of the original image is obtained by using the enlarged and interpolated transfer function. This processing method is effective for processing a large image.

The basic concept of speed up processing, which is effective for restoring a large image, will be explained hereafter.

Only repetition of the processes needs long time for convergence. This disadvantage particularly emerges in a large image. On the other hand, deconvolution in frequency space is very attractive because of high speed calculation using Fast Fourier Transform (FFT). Here, optical deconvolution means that an initial image without a blur and the like is restored by removing fluctuation factors such as distortion, a blur and the like from a blurred image.

An ideal state of an image is expressed as the following output of convolution integration, where input is in(x), output: ou(x), transfer function: g(x) and output: ou(x).

ou(x)=∫in(t)g(x−t)dt (3)

Here, “∫” is an integration mark. The formula (3) becomes the following in a frequency space:

O(u)=I(u)G(u) (4)

Deconvolution is a method of obtaining unknown input in(x) from the already-known output ou(x) and the transfer function g(x). In order to do that, if I(u)=O(u)/G(u) can be obtained in a frequency space, then, returning the result of I(u) to a real space attains the unknown input In(x).

The formula (3) becomes “ou(x)+α(x)=∫in(t)g(x−t)dt+α(x)” in actual due to a noise and the like. Here, “ou(x)+α(x)” is already known, but ou(x) and α(x) are unknown. Even if the above formula is approximately solved as an inverse issue, it is difficult to obtain a sufficient solution in actual. Therefore, the process flow, shown in FIG. 3, solves a solution by making jn(x) converge using a repetition method if jn(x) satisfies the formula:

ou(x)+α(x)=∫in(t)g(x−t)dt+α(x)□∫jn(t)g(x−t)dt.

Here, if “α(x)□ou(x)”, the relationship of jn(x)□in(x) is satisfied.

The above method obtains a sufficient solution because of repeating and making the calculation converge within an entire data region. But, it has a disadvantage of taking long time if it handles many numbers of data. On the other hand, under an ideal state without a noise, a solution can be attained with high speed by calculating deconvolution in a frequency space. Accordingly, a combination of these two methods can attain a sufficient solution with high speed.

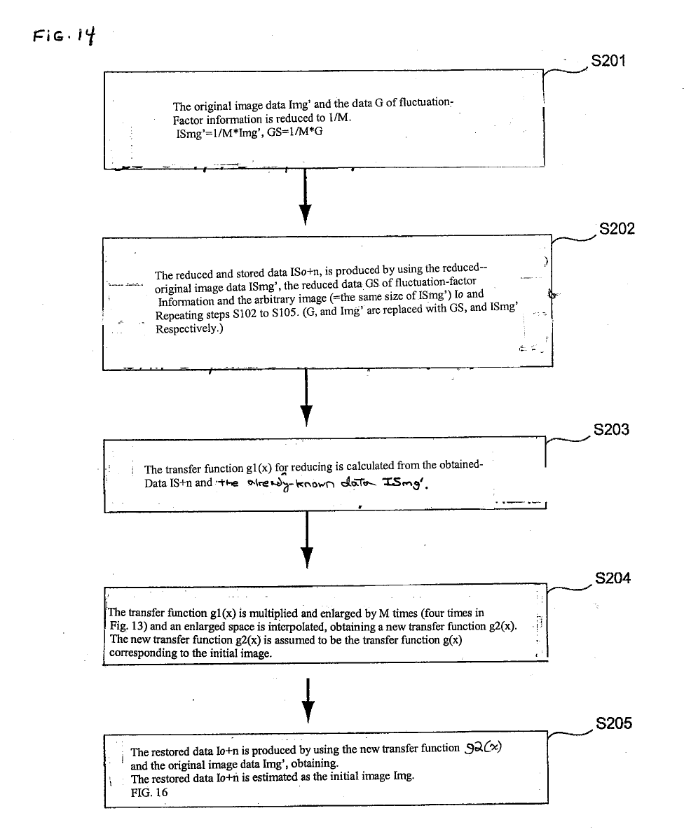

Two methods are substantial ways of this processing. First, thinning data obtains the reduced data. This thinning method will be explained as a second method using the method shown in FIG. 3. Upon thinning data, if the original image data Img′ comprises pixels, 11 to 16, 21 to 26, 31 to 36, 41 to 46, 51 to 56 and 61 to 66 for example as shown in FIG. 13, pixels are thinned every other pixel, producing reduced original image data ISmg′, one fourth of the original data that comprises pixels 11,13,31,33,35,51,53 and 55.

Namely, the original image data Img′ and the data G of fluctuation information are thinned, producing the thinned and reduced original image data ISmg′ and reduced data GS of fluctuation factor information. Then, the processes as shown in FIG. 3 are repeated using reduced original image data ISmg′ and the reduced data GS of fluctuation factor information. Finally, reduced restored data ISo+n is obtained as sufficiently reduced data approaching to the reduced initial image ISmg before it fluctuates to the reduced original image data ISmg′.

The reduced, approximated, and restored data ISo+n is assumed to be the reduced-initial image ISmg before it fluctuates to the reduced-original image ISmg′, namely the reduced and correct image Img. Then, the reduced-original image data ISmg′ is considered to be a convolution-integration of the reduced and stored data ISo+n with the transfer function g(x). Then, the transfer function g1(x) is obtained from the reduced and stored data ISo+n and the reduced-original image data ISmg′.

The reduced and stored data ISo+n is sufficiently enough data, but still approximated data. Therefore, the transfer function g(x) of the restored data Io+n and the original image data Img′ is not the transfer function g1(x), obtained by repeating the processes of reduced data. Hence, the transfer function g1(x) is calculated from the reduced and stored data ISo+n and the original image data Img′. Then the transfer function g1(x) is enlarged and a space between enlarged portions is interpolated. This enlarged and interpolated function is a modified new transfer function g2(x), which is defined as the transfer function g(x) for the original image data Img′ as initial data. The new transfer function g2(x) is obtained through multiplying the obtained transfer function g1(x) by inversed-multiple numbers of reduction ratio of reduced original image data, and then interpolating a value between enlarged spaces by a linear interpolation or a spline interpolation or the like. For example, upon thinning pixels along vertical and horizontal directions to a half as shown in FIG. 13, the reduction ratio becomes one fourth. Hence, inversed-multiple numbers are four.

Then, by using the modified new transfer function g2(x)(=g(x)), deconvolutuion (removing blur portions from a blurred image group by calculation) is calculated in a frequency space, attaining the perfect restored data Io+n of an entire image, assuming it to be the intrinsic-correct image Img (an initial image) without a blur.

FIG. 14 is a flow chart of the above processes.

Step S201 reduces the original image data Img′ and the data G of fluctuation-factor information to 1/M. In the example shown in FIG. 13, the reduction ratio 1/M is one fourth. Steps S102 to S105, shown in FIG. 3, are repeated by using the reduced-original image data ISmg′ and the reduced data GS of fluctuation-factor information and the arbitrary image (a predetermined image)Io. Then, the reduced and stored data ISo+n, approaching an image having a small value of the difference data σ, namely, the reduced and initial image data ISmg that is an image before it fluctuates to the reduced-original image data ISmg′ (step S202). At this time, “G,Img′, and Io+n” shown in FIG. 3 are replaced with “GS, ISmg′ and ISo+n”.

The transfer function g1(x), which transforms the reduced-original image data ISmg′ to the reduced-restored data ISo+n, is calculated from the obtained, reduced-restored data ISo+n and the already-known, and reduced-original image data ISmg′ (step S203). Then, step S204 enlarges the transfer function g1(x) by M times (four times in FIG. 13) and interpolates an enlarged space by an interpolation method such as linear method, obtaining a new transfer function g2(x). The new transfer function g2(x) is assumed to be the transfer function g(x) corresponding to the initial image.

Next, deconvolution is performed using the new transfer function g2(x) and the original image data Img′, obtaining the restored data Io+n. The restored data Io+n is defined as the initial image (step S205). Accordingly, high speed processing can be attained by combining a) repetition of the processes with b) obtaining the transfer functions g1(x) and g2(x) and using the transfer functions g2(x) for the processes.

Here, in this second processing, the attained and correct image and the assumed and restored data Io+n may be used as the initial image data Io shown in FIG. 3 and further processing may be repeated by using the data G of fluctuation-factor information and the blurred original image Img′.

Other method of using a reduced image is to retrieve a part of the original image data Img′ and define it as the reduced original image data ISmg′. This method will be explained as a third method using the method shown in FIG. 3. If the original image data Img′ comprises pixels, 11 to 16, 21 to 26, 31 to 36, 41 to 46, 51 to 56 and 61 to 66 for example as shown in FIG. 15, a central region comprising pixels 32,33,34,42,43 and 44 is retrieved so that the reduced-original image data ISmg′ is produced.

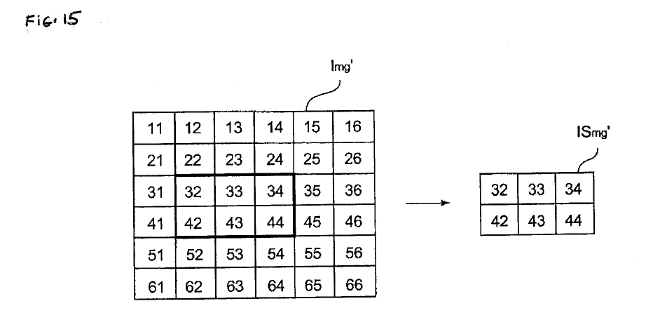

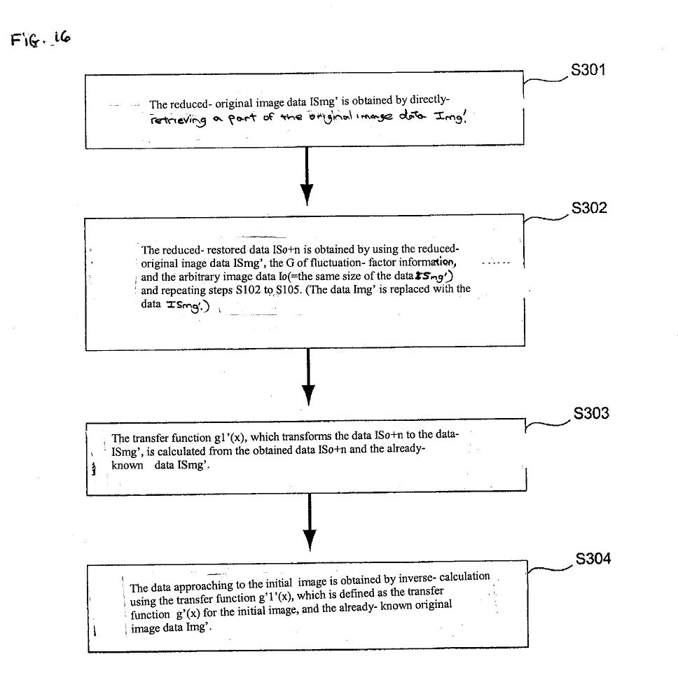

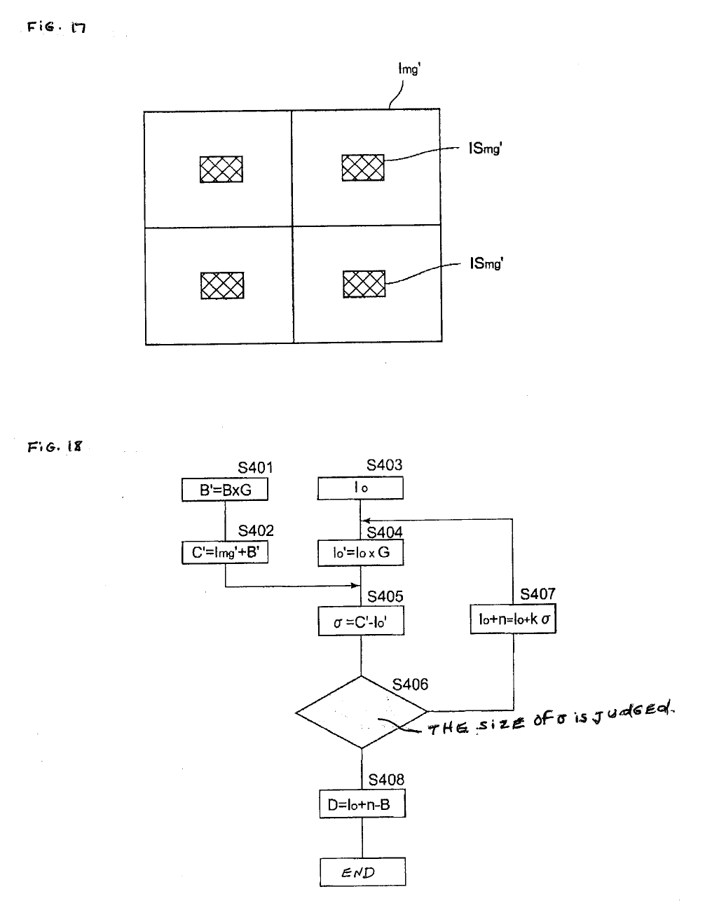

The details of the third processing method will be explained referring to the flow chart in FIG. 16.

In the third method, first, step S301 obtains the reduced-original image data ISmg′, described above. Next, steps S102 to S105 as shown in FIG. 3 are repeated by using the reduced original image data ISmg′, the data G of fluctuation-factor information, the initial image data Io, an arbitrary image data, which has the same size (the same numbers of pixels) of the reduced-original image data ISmg′. This repetition obtains the reduced-stored data ISo+n(step S302). This process replaces “Img′” and “Io+n” in FIG. 3 with “ISmg′” and “ISo+n” respectively.

The transfer function g1′(x), which transforms the reduced-restored data ISo+n to the reduced-original image data ISmg′, is calculated from the obtained and reduced-restored data ISo+n and the already-known and reduced-original image data ISmg′ (step S303). Next, the calculated-transfer function g1′(x) is defined as the transfer function g′(x) corresponding to the initial image Img. Then, the initial image Img is obtained by inverse-calculation using the transfer function g1′(x)(=g′(x)) and the already-known original image data Img′. Here, the calculated result becomes data of an image approaching to the initial image Img.

Accordingly, high speed processing can be attained by combining a) repetition of the process with b) obtaining and using the transfer function g′1(x) for the process. Here, the obtained-transfer function g1′(x) may be modified using the data G of fluctuation-factor information instead that the transfer function g1′(x) is defined as the entire transfer function g′(x).

Accordingly, the above third method as a high speed process does not restore the entire regions of an image by repeating the processes, but repeats the processes of a part of regions to attain a favorite restored image instead. By using the result of the repetition, the transfer function g1′(x) corresponding to the part is obtained. Finally an entire image is restored by using such transfer function g1′(x) itself or the modified (enlarged) it. Here, the above-retrieved region must be sufficiently larger than the fluctuated regions. In the example shown in FIG. 5, an image is fluctuated across three pixels, needing to retrieve a region having over three pixels.

In case of retrieving the reduced region as shown in FIGS. 15 and 16, the original image data Img′ may be divided into four regions as shown in FIG. 17 for example and a part in each of divided regions may be retrieved. Then, four reduced-original image data ISmg′ in the small part may be repeatedly processed, restoring data for each of four divided regions and integrating restored and four-divided images into one image as an entire restored image. Upon dividing the region into plural numbers, it is preferably certain to retain superimposed plural regions (superimposed regions). Further, it is preferable to use the average value in the superimposed region as the restored image or smoothly and continuously connect the restored image in the superimposed region.

[Third embodiment] In the third embodiment, an image processing device has the same structure of the image processing device 1 in the first and the second embodiments. But, a processing method performed by the processing unit 4 is different. But, the basic concept of the repetition of the processes in the first and second embodiments is the same in the first embodiment. Hence, major differences will be explained.

Further, upon processing an image that has a sharp change of a contrast with basic operations from FIGS. 1 to 12, converging the image to a favorite-approximated image may be delayed. Namely, there are some cases in which the convergence speed of repeating the processes are slow and many numbers of repetition are needed depending an object to be shot as an original image. Hence, such problem will be solved by the following fourth method.

In case when an object to be processed has a sharp contrast change, repetition numbers are increased in order to obtain an image approaching to an initial image by using the repetition of restoring the image with a method shown in FIG. 3. Therefore, the blurred image data B′ is produced by using the data G of fluctuation-factor information at the time of shooting from the already-known image data B. Then the blurred image data B′ is superimposed on the shot original image (the blurred image) data Img′, creating superimposed data “Img′+B′”. The superimposed image is restored by the process shown in FIG. 3 thereafter. Then, the already-known image data B is removed from the restored data Io+n and the desired restored image data Img. The restored data of an image approaching to the original data before fluctuation is retrieved.

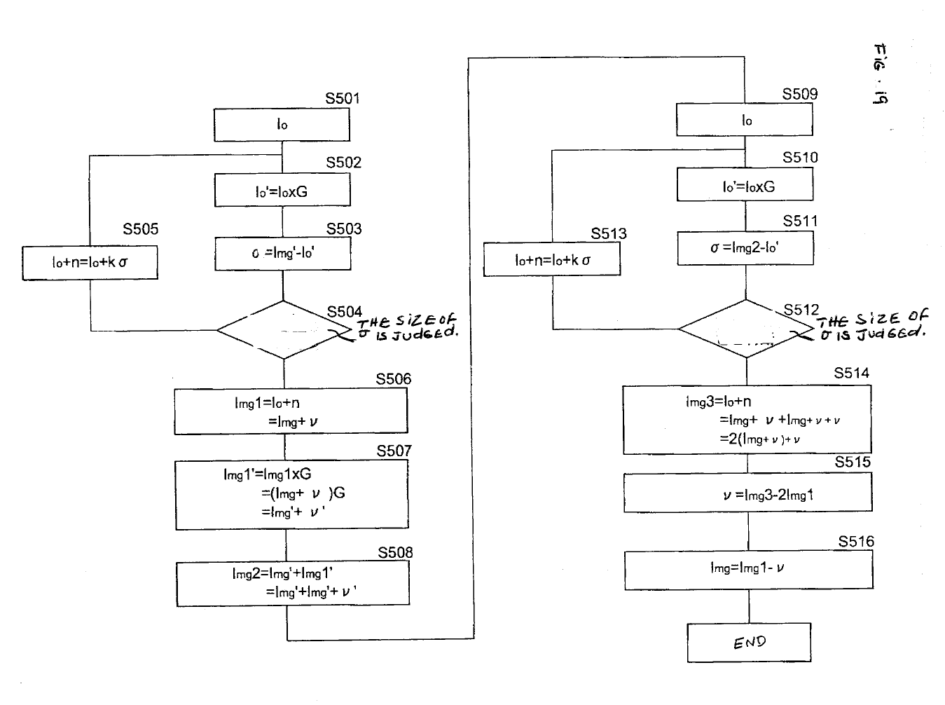

Details of this fourth method will be explained referring to FIG. 18.

First, blurred image data B′ as image data for superimposing is produced by using the data G of fluctuation-factor information from image data B as already-known image data of which contents are known (step S401). Namely, this blurred image data B′ is generated by applying a blur to image data B with fluctuation factor information. Then, an image data C′=Img′+B′ is produced by the original image data Img′ with the B′ (step S402). The data Img′ is a shot-original image (a blurred image), an object to be processed. Accordingly, steps S401 and S402 produce superimposed image data C′.

Next, the arbitrary image data Io is prepared (step S403). The image data Io may be the shot and blurred image data Img′ or may be any image data having solid black, solid white, solid gray, check and the like. Then step S404 obtains the comparison data Io′ as the blurred image by inputting the arbitrary image data Io to the formula (1) instead of the data Img. Namely, steps S403 and S404 produce the comparison data.

Next, step S405 compares the comparison data Io′ with the superimposed image data C′ to calculate the difference data σ. Further, step S406 judges whether the difference data σ is equal to or more than a predetermined value or not. Then, step S407 produces newly restored image data (restored data), if the difference data σ is equal to or more than a predetermined value. Namely, the newly restored data Io+n is produced by allocating the difference data σ to the arbitrary image data Io based on the data G of fluctuation factor information. Steps S404, S405 and S406 are repeated thereafter.

Step S406 estimates the restored data Io+n as superimposed image data in which an image that approaches to the intrinsic and correct image without a blur is superimposed on the already-known image data B. Accordingly, steps S403 to S407 produce the superimposed and restored image data.

Steps S403 to S407 producing superimposed and restored image data are similar to the above mentioned process of producing the restored data shown in FIG. 3. Hence, the basic operations explained in FIG. 3 can be applied to a method of setting the data G of fluctuation-factor information and judging the size of the difference data σ in the above steps.

Next, the already-known image data B is removed from the superimposed-restored image data. Step S408 produces the restored data D approaching to an original data before fluctuation. The restored data D produced by step S408 is assumed to be an image data approaching the image data Img without a blur and stored in the recording unit 5.

Even if the intrinsic and correct data Img includes a sharp contrast change, the above method reduces the sharp contrast change and numbers of repeating the restoring process by adding the already-known image data B. The already-known image data is data having less contrast comparing to the intrinsic and correct data Img, or data of no contrast or the shot-image data Img′. In particular, the superimposed image data efficiently becomes image data having low contrast by using data having less contrast comparing to the intrinsic and correct data Img or data of no contrast. Further, the numbers of repetitions of the processes are efficiently reduced.

[Fourth embodiment] Further, a fifth method of the processes shown in FIG. 19 is applied as a method of processing an object which is difficult to be processed or a fast speed process. For example, if the numbers of repetitions are increased, output image further approach to a favorite restored image. But it takes longer time to process the image. Hence, an image obtained by repeating the processes in some degree is used for calculating error components, included in the image, and then a favorite restored image, namely the restored data Io+n can be obtained by removing the calculated error component data from the restored data.

The details of this method will be explained as the fourth embodiment thereafter.

First, if a desired and correct image is defined as A, a shot and original image is A′ and an error component is ν, image data restored from the shot and original image A′ becomes A+ν and data for comparison with a blur produced by the restored data becomes A′+ν.′ Then, “A′” is added to “A′+ν′” and these added data become “A+ν+A+ν+ν” through restoring process. These data are “2A+3ν” or “2(A+ν)+ν”. “A+ν” is already obtained by the previous process. Therefore, “ν” can be obtained by calculating “2(A+ν)+ν−2(A+ν)”. Hence, “ν” is removed from the restored image data “A+ν”, obtaining the desired and correct image A.

Details of the fifth method will be explained referring to FIG. 19.

First, the arbitrary image data Io is prepared (step S501). The initial image data Io may be the shot and blurred image data Img′ or may be any image data having solid black, solid white, solid gray, check and the like. Step S502 obtains the comparison data Io′ as the blurred image by inputting the arbitrary image data Io, which becomes the initial image, to the formula (1) instead of the data Img. Next, the difference data σ is calculated by comparing the original image data Img′ as the shot and blurred image A′ with the comparison data Io′(step S503).

Next, step S504 judge whether the difference data σ is equal to or more than a predetermined value or not. Then, step S505 produces newly restored image data (restored data) if the difference data σ is equal to or more than a predetermined value. Namely, the newly restored data Io+n is produced by allocating the difference data σ to the arbitrary image data Io based on the data G of fluctuation factor information. Steps S502, S503 and S504 are repeated thereafter.

Step S504 halts data-restoring processes of S501 to S504 if the difference data σ becomes smaller than the predetermined value. At this point, the restored data Io+n is defined as a first restored data Img1(step S506). Then, the first restored data Img1 is assumed to be image data including the image data Img of the desired image A and the error component data ν, namely data Img+ν.

In the first embodiment referring to FIG. 1 to FIG. 12, step S504 judging the size of the difference data σ, repeats of the restoring process for data until the time when the difference data σ is sufficiently small such as 5 or 0.5 and the shot, blurred and original image data Img′ and the comparison data Io′ as the blurred image are judged to approximately be the same value. On the other hand, in the second embodiment, restoring steps S502 to S505 for data are halted at the time when the difference data σ is larger value compared to the approximated value of the shot, blurred and original image data Img′ and the comparison data Io′ as the blurred image. For example, when the above approximated data becomes a half or one third of the first calculated value of the difference data σ, data restoring steps S502 to S505 are halted.

Next, the error component data is calculated. First, step S507 inputs the first restored data Img1 instead of the data Img of the formula (1) and obtains image data Img1′, produced in a manner that the first restored data Img1 (=Img+ν) is blurred by the data G of fluctuation-factor information. The image data Img1′ is the comparison data A′+ν′ as the blurred image and the data Img′+ν′.

Then, an added data Img2′ is obtained by adding the image data Img′ of the original image A′ as a shot and blurred image to the image data Img′+ν′ blurred from the image data Img1 (step S508). Then, the added data Img2′ is treated as the shot-blurred image and restored (steps S509 to S513). Steps S509 to S513 are a similar restoring processes of steps S501 to S505 except a process in which the shot and blurred image Img′ is added to the added data Img2′.

First, the arbitrary image data Io is prepared (step S509). Then, the comparison data Io′ as the blurred image is obtained by inputting the arbitrary image data Io to the formula (1) instead of Img as step S510. Next, the added data Img2′ is compared with the comparison data Io′ to calculate the difference data σ (step S511).

Further, step S512 judges whether the difference data σ is equal to or more than a predetermined value or not. Then, step S513 produces newly restored image data (restored data) if the difference data σ is equal to or more than a predetermined value. Namely, the newly restored data Io+n is produced by allocating the difference data σ to the arbitrary image data Io based on the data G of fluctuation factor information. Steps S510, S511 and S512 are repeated thereafter.

Restoring processes of steps S510 to S513 are completed if the difference data σ becomes smaller than a predetermined value in step S512.

The restored data Io+n at the time of completing steps S510 to S513 is defined as a second restored data Img3 (step S514). The contents of the second restored data Img3 are “A+ν+A+ν+ν”, namely “Img+ν+Img+ν+ν”, or “2(Img+ν)+ν”. Accordingly, the contents of added data Img2′ are “Img′+Img′+ν′”. Hence, the restoring steps from S509 to S513 restore “Img′” and “ν′” as “Img+ν” and “ν” respectively.

Then, the error component data ν is obtained (step S515) if the second restored data Img3(=2(Img+ν)+ν) is subtracted by the data 2Img1(=2(Img+ν)), since step S506 already obtained “Img+ν” as the first restored data Img1. Namely, steps S507 to S515 calculate the error component data.

Then, step 516 subtracts the error component data ν from the first restored data Img1 to obtain the original restored data as the original image Img before fluctuation. Further, the restored data Img obtained by step S516 is stored in the recording unit 5 Here, the recording unit 5 may store the initial image data Io and the data G of fluctuation factors information and send them to the processing unit 4 if they are necessary.

[Other embodiment] The image processing device 1 with respect to various embodiments of the invention has been explained. But, it is possible to modify it within the spirit of the invention. For example, the processing unit 4 performs processes with software. But, hardware comprising parts sharing their workload together may be used for processing.

Further, as the original image, an object to be processed, some processed data may also be used such that shot image data may be color-compensated or Fourier-transformed. Further, as the comparison data, some processed data except the data G of fluctuation-factor information may also be used such that the data G may be color-compensated or Fourier-transformed. Further, the data of fluctuation factor information may include not only data of blur factors, but information simply varying an image or improving image quality.

Further, if the numbers of repetition are automatically set or fixed by the image processing device 1, such numbers may be changed depending on the data G of fluctuation-factor information. When data of one pixel is dispersed to many other pixels by blurring, the numbers of repetition may be increased for example. But when the dispersion is small, the numbers of repetition may be decreased.

Further, when the difference data σ becomes dispersed during repetition of the processes, namely increased, the processes may be halted. Regarding judging the dispersion about the difference data σ, if it is observed that the average value of the difference data σ becomes larger than a previous value for example, the difference data σ may be judged to be dispersed. Further, if the dispersion occurs once, the processes may be halted. Otherwise, if the dispersion is continuously occurred twice or predetermined numbers, the processes may be halted.

When an input is changed to be an abnormal value during repeating the processes, the processes may be halted. When the input is 8 bits and a value to be changed exceeds 255, the processes may be halted. When an input as new data is changed to be an abnormal value during repeating the processes, a normal value may be used instead of such abnormal value. For example, when a value, surpassing 255 among 0 to 255 of 8 bits, is input, the processes may be executed under a condition when the input data is a maximum value as 255. Namely, if the restored data include an abnormal value (a value surpassing 255 in the above example) more than a permitted value (a value of 0 to 255 in the above example), the processes may be halted. Otherwise, if the restored data includes an abnormal value more than a permitted value, the abnormal value may be replaced with the permitted value and, then the processes may be continued.

Further, when the restored data is produced as an output image, data may go out of the region specified as an image to be restored depending on the data G of fluctuation-factor information. In such case, data going out of the region should be input to an opposing side. Further, if data come from the outside of the region, the data may be brought into an opposing side. If image data, allocated to pixels located lower than the most bottom position of the region where pixels XN1 (the Nth row and the first column) is located, is generated for example, the location will be out of the region. In such case, the data will be allocated to the pixels X1 (the first row and the first column) at the most top position directly above the pixel XN1. The data at the pixel XN2 (the Nth row and the second column) will also be allocated to the pixels X12(the first row and the second column adjacent to the pixel X11) at the most top position directly above the pixel XN2 (the Nth row and the second column) adjacent to the pixel XN1 through a similar manner. Accordingly, in a case of producing the restored data, when data occurs out of the region to be restored, the data is rearranged at the positions opposing to the position where the data occurs toward one of the vertical, horizontal or oblique directions within the region to be restored. Such rearrangement is able to certainly restore the data in the region to be restored.

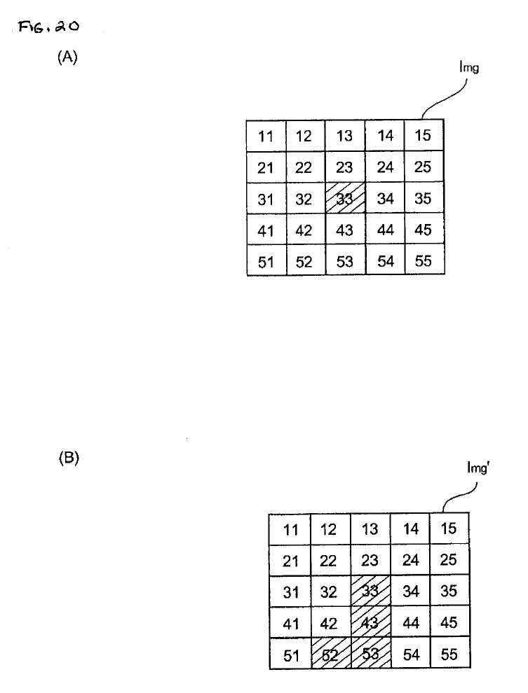

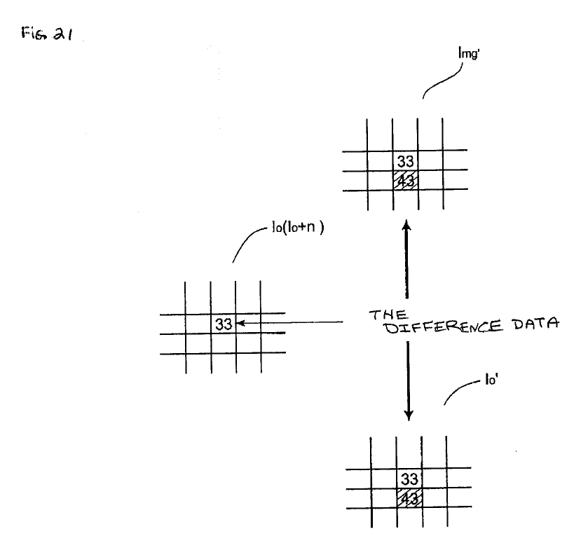

In case of producing the restored data Io+n, the barycenter of fluctuation factors such as a blur and the like may be calculated. Then, the difference of only the barycenter or the variable powers of the difference may be added to the previous restored data Io+n₋₁. This approach as a method of using the barycenter of fluctuation factors is explained as a sixth method using the method shown in FIG. 3 in detail with referring to FIG. 20 and FIG. 21.

As shown in FIGS. 20(A) and 20(B), the correct image data Img comprises pixels 11 to 15, 21 to 25, 31 to 35, 41 to 45 and 51 to 55. The pixel 33 is paid an attention as shown in FIG. 20(A). When the pixel 33 is moved to positions of the pixels 33, 43, 53 and 52 due to hand-jiggling, the image at the pixel 33 in the original image data Img′ as a blurred image affects images at the pixels 33, 43, 53 and 52 as show in FIG. 20(B).

In this blurring due to the move of the pixel 33, if the pixel stays at the position of the pixel 43 for the most longest time, the barycenter of blurs, namely fluctuation factors, of the original image data Img′ comes to the position of the pixel 43 with respect to the pixel 33 in the corrected image data Img. By this movement, as shown in FIG. 21, the difference data σ is calculated as the difference of data at the pixel 43 between the original image Img′ and the comparison data Io′. The difference data σ is added to the pixel 33 of the initial image data Io and the restored data Io+n.

In the previous example, among three barycenters “0.5”, 0.3” and “0.2”, the highest value is “0.5”, which will be a self center. Hence, without considering allocation of “0.3” and “0.2”, only “0.5” or the variable power of “0.5” is allocated to the self position. Such processing is preferable when energy of a blur concentrates.

Further, in a case of producing the restored data Io+n, the allocation ratio k may not be used. Instead, the difference data σ corresponding to a pixel to be treated may be directly added to the pixel in the previous restored data Io+n−1. Otherwise, the difference data σ may be variably powered and, then added to the pixel. Further, the data kσ (the value as “a renewing amount” in FIG. 10 and FIG. 12) after the difference data σ is allocated, may be variably powered and added to the previous restored data Io+n−1. Processing speed is fairly improved by properly using these methods

The summaries of the above-mentioned various methods are;
(1) a method of allocating the difference data σ by using allocation ratio k (a method of the embodiment),
(2) a method of thinning data and combining the data with an inverse issue (an inverse issue method),
(3) a method of retrieving a reduced region and combining the region with an inverse issue (an inverse issue and retrieving region method),
(4) a method of superimposing a predetermined image, repeating the processes and then removing the predetermined image (a method of countermeasure against a difficult image and superimposing it),
(5) a method of removing a calculated error from a restored image including an error (a error removing method),
(6) a method of detecting the barycenter of fluctuation factors and using data in the barycenter (a barycenter method), and
(7) a method of variably powering difference or the difference data σ corresponding to a pixel (a method of corresponding to a pixel).
   Programs for these methods may be stored in the processing unit 4 and any of them may be automatically selected depending on user's selection or kinds of images. As an example of selecting these methods, the statuses of fluctuation factors are analyzed and one of these seven methods is selected based on this analysis.

Further, any pluralities of these methods (1) to (7) may be stored in the processing unit 4 and any of them may be automatically selected depending on user's selection or kinds of images. Further, any pluralities of these seven methods may be selected and alternately used every one routine or in series. Otherwise, one method may be used during initial several times and other methods may be used thereafter. The image processing device 1 may use methods which are different from one of or any of the above-mentioned seven methods.

Further, the above methods may be programmed. Such programmed contents may be stored in a memory such as compact disc (CD) DVD, universal serial bus (USB) and read by a computer. In this case, the image processing device 1 may include a means for reading the program stored in the medium. Further, programmed contents may be input to a server out of the image processing device, down-loaded and used if they are necessary. In such case, the image processing device 1 may include a communication means down-loading the program stored in a medium.

1. An image processing device comprising a processing unit that produces restored data approaching to an image before fluctuating by repeating the following processes:
generating comparison data from arbitrary image data by using data of fluctuation-factor information that triggers image fluctuation;
comparing the comparison data with original image data, an object to be processed:
producing restored data by allocating different data to the arbitrary image data through using the data of fluctuation-factor information, the different data being the difference between the comparison data and the original image data; and
substituting the restored data for the arbitrary image data.

2. An image processing device comprising a processing unit that performs the following functions:
producing reduced and restored data that approaches to reduced initial image data before fluctuating to reduced original image data by repeating the following processes: generating comparison data from predetermined image data by using data of fluctuation-factor information that triggers image fluctuation; comparing the comparison data with reduced original image data that comprises a part of original image data, an object to be processed: producing the reduced and restored data by using difference data as the difference between the comparison data and the reduced-original data; substituting the reduced and restored data for the predetermined image data; and further substituting the obtained, reduced and restored data for the previous, reduced and restored data:
obtaining a transfer function from the reduced-original image data and the reduced and restored data that approaches to the reduced-initial image data: and
producing restored data that approaches to the initial image before fluctuating to the original image by using the transfer function.

3. The image processing device according to claim 2, wherein the reduced original image data is obtained by thinning the original image data, and wherein
the processing unit obtains a new transfer function by reversely multiplying the transfer function with the reduce ratio of the reduced-image data to the original image and interpolating an enlarged space and the processing unit produces restored data approaching to the initial image by using the new transfer function.

4. The image processing device according to claim 2, wherein the reduced-original image data is directly retrieved from a part of a region of the original image data

5. An image processing device comprising a processing unit that performs the following functions:
generating data for superimposing from already-known image data in which the content of image data is specified, by using data of fluctuation-factor information that triggers image fluctuation;
producing superimposed image data by superimposing the data for superimposing on original image data, an object to be processed;
producing the comparison data from arbitrary image data by using data of fluctuation-factor information that triggers image fluctuation;
producing superimposed and restored image data in which the already-known data is superimposed on the image approaching to an initial image before fluctuating, by repeating the following processes: comparing the comparison data with the superimposed image data; producing restored data by using difference data, which is the difference between the comparison data and the superimposed data; and substituting the restored data for the arbitrary image data;
producing restored image data approaching to the initial image before fluctuation by removing the already-known image data from the superimposed and restored image data.

6. The image processing device according to claim 5, wherein
the already-known image data is image data having less contrast comparing to the initial image before fluctuation.

7. An image processing device comprising a processing unit that performs the following functions:
producing first restored data approaching to the initial image data before fluctuation by repeating the following processes: generating comparison data from arbitrary image data by using data of fluctuation-factor information that triggers image fluctuation; producing restored data by comparing the comparison data with the original image data, an object to be processed, and using difference data, which is difference between the comparison data and the original image data; and substituting the restored data for the arbitrary image data;
calculating error component data included in the first restored data; and
producing restored image data approaching to the image before fluctuation by removing the error component data from the first restored data.

8. The image processing device according to claim 7, wherein the process of calculating the error component data includes:
producing fluctuated image data of first restored data from the first restored data by using data of fluctuation factor information;
adding original image data, an object to be processed, to the fluctuated image data in order to obtain added data;
producing second restored data by restoring the added data; and
obtaining the error component data by using the second restored data and the first restored data.

9. The image processing device according to claim 1, wherein the processing unit halts the repetition of the processes if the difference data becomes equal to or less or smaller than a predetermined value.

10. The image processing device according to claim 1, wherein the processing unit halts the repetition of the processes if the number of the repetition becomes a predetermined number.

11. An image processing device comprising a processing unit that performs the following functions:
generating comparison data from predetermined image data by using data of fluctuation-factor information that triggers image fluctuation;
comparing the comparison data with original image data, an object to be processed:
halting the previous processes and treating the predetermined image, a base for the comparison data, as an original image before fluctuation if difference data between the comparison data and the original image data is equal to or less or smaller than a predetermined value; and
repeating the previous and following processes if the difference data is equal to, or more or larger than a predetermined value;
producing restored data by allocating the difference data to the predetermined data with using the data of fluctuation factor information: and
substituting the restored data for the predetermined image.

12. An image processing device comprising a processing unit that performs the following functions:
generating comparison data from arbitrary image data by using data of fluctuation-factor information that triggers image fluctuation;
comparing the comparison data with reduced-image data composed of a part of original image data, an object to be processed:
producing reduced and restored image data approaching to a reduced-initial image before fluctuating to the reduced-original image data by repeating the previous and following processes if difference data, which is difference between the comparison data and the reduced-image data, is equal to, or more, or larger than a predetermined value:
producing reduced and restored data by using the difference data;
substituting the reduced and restored data for the predetermined image; and
further substituting the obtained, reduced and restored data for the previous, reduced and restored data; and
producing restored data approaching to an initial image before fluctuating to the original image using a transfer function obtained by the following processes if the difference data is equal to, or less, or smaller than a predetermined value:
halting the previous processes;
treating the reduced and restored data, which is a base for the comparison data, as the approximated, reduced and restored data and a reduced initial image before fluctuating to the original image; and
obtaining the transfer function from the reduced original image data and the approximated, reduced and restored data.

13. The image processing device according to claim 12, wherein the reduced original image data is formed by thinning the original image data, and wherein the processing unit obtains a new transfer function by reversely multiplying a transfer function with the reduce ratio of the reduced image data to the original image and interpolating an enlarged space and, then, the processing unit produces restored data approaching to the initial image by using the new transfer function.

14. The image processing device according to claim 12, wherein the reduced original image data is directly retrieved from a part of a region of the original image data.

15. The image processing device according to claim 11 wherein the processing unit halts the repetition of the processes if the number of the repetition becomes a predetermined number.

16. The image processing device according to claim 12, wherein the processing unit halts the repetition of the processes if the number of the repetition becomes a predetermined number.
